(19) United States
(12) Patent Application Publication
(10) Pub. No.: US 2019/0279233 A1
(43) Pub. Date: Sep. 12, 2019

(54) Real-World Analytics Monitor

(71) Applicants: Jonah Friedl, Kirkland, WA (US); David Greschler, Kirkland, WA (US)

(72) Inventors: Jonah Friedl, Kirkland, WA (US); David Greschler, Kirkland, WA (US)

(21) Appl. No.: 16/295,951

(22) Filed: Mar. 7, 2019

Related U.S. Application Data
(60) Provisional application No. 62/639,658, filed on Mar. 7, 2018.

(51) Int. Cl. G06Q 30/02; G06F 16/23; G06N 7/00; G06K 7/14; G06Q 10/06

(52) U.S. Cl. CPC G06Q 30/0201; G06F 16/23; G06N 7/005; G06K 7/1417; G06Q 30/0244; G06Q 30/0204; G06Q 30/0269; G06Q 30/0261; G06Q 10/06398; G06K 7/14

(57) ABSTRACT

A system to provide feedback for physical customer-employee interactions analogous to the data provided by web site analytics tools for online merchants. In particular, the system may capture images and/or voices of customers and/or employees and may determine qualities of the customer experience using determinations of customer and/or employee sentiment and/or other indications of the quality of the experience such as duration, products purchased, and tips. These determined qualities may be used to improve customer service and/or to provide feedback to employees about their customer service performance and/or to determine the ROI of a marketing campaign.

### FIELD

The disclosure relates to a real-world analytics monitor.

### BACKGROUND

Today, measuring and improving the customer experience, employee performance, and marketing in physical face-to-face commerce environments is a manual process that relies primarily on customer surveys and other customer-initiated actions like monitoring online comments and complaints. These approaches are generally based on small sample sizes and self-selected populations, which both limit their accuracy. They also require significant time between when data is collected and analyzed and when corrective actions can be taken.

### SUMMARY

The tools described herein provide feedback for physical customer-employee interactions analogous to the data provided by web site analytics tools for online merchants. In particular, they may capture images and/or voices of customers and/or employees and may determine qualities of the customer experience using determinations of customer and/or employee sentiment and/or other indications of the quality of the experience such as duration, products purchased, and tips. These determined qualities may be used to improve customer service and/or to provide feedback to employees about their customer service performance.

In one aspect, a method for monitoring a customer experience may include collecting profile data (e.g., a still image, a video, a sound, a gait characteristic, a silhouette, a QR code, an RFID code, a footprint scan, a fingerprint scan, a skeletal scan, and/or a brain scan) for a customer (e.g., demographic data such as age, gender, family status, residence data, and/or job data), comparing the profile data with a database of customers and using the comparison to determine that the customer matches a record in the database and is a repeat customer or that the customer does not match any record in the database and is a new customer. The method may further include, if the customer is determined to be a repeat customer, updating the database to add a current visit to the matched record, or if the customer is determined to be a new customer, adding a record of the customer to the database. The method may also include recording at least one feature of the experience of the customer in the database (e.g., products shown to the customer, products purchased by the customer, identity of employee serving customer, number of employees serving customer, duration of customer visit, time of customer visit, location of customer visit, method of payment used by the customer, customer sentiment, employee sentiment, logos viewed by customer, and/or scenes viewed by customer) and associating the recorded feature with the customer. Profile data may be collected with, for example, a mobile phone, a security camera, or a point-of-sale device, and may be collected with one or more than one device or type of device. It may include collecting profile data from the customer and storing the data only if the face size of the customer falls within a selected range, or only if an estimated age of the customer falls within a selected range. It may include displaying an advertisement to the customer. Collecting profile data may include determining a location of the customer (for example, with a GPS system), and may also include checking that the collected data is not that of an employee.

In another aspect, a system for monitoring a customer experience may include means for collecting profile data (e.g., a still image, a video, a sound, a gait characteristic, a silhouette, a QR code, an RFID code, a footprint scan, a fingerprint scan, a skeletal scan, and/or a brain scan) for a customer (e.g., demographic data such as age, gender, family status, residence data, and/or job data), comparing the profile data with a database of customers and using the comparison to determine that the customer matches a record in the database and is a repeat customer or that the customer does not match any record in the database and is a new customer. The system may further include means for, if the customer is determined to be a repeat customer, updating the database to add a current visit to the matched record, or if the customer is determined to be a new customer, adding a record of the customer to the database. The system may also include means for recording at least one feature of the experience of the customer (e.g., products shown to the customer, products purchased by the customer, identity of employee serving customer, number of employees serving customer, duration of customer visit, time of customer visit, location of customer visit, method of payment used by the customer, customer sentiment, employee sentiment, logos viewed by customer, and/or scenes viewed by customer) in the database and associating the recorded feature with the customer. Profile data may be collected with, for example, a mobile phone, a security camera, or a point-of-sale device, and may be collected with one or more than one device or type of device. It may include means for collecting profile data from the customer and means for storing the data only if the face size of the customer falls within a selected range, or only if an estimated age of the customer falls within a selected range. It may include means for displaying an advertisement to the customer. Means for collecting profile data may include means for determining a location of the customer (for example, a GPS system), and may also include means for checking that the collected data is not that of an employee.

In another aspect, a method of monitoring employee performance may include assembling a database of instances of live employee-customer interactions, where for each record corresponding to a live employee-customer interaction in the database, the database includes a customer satisfaction indicator (e.g., by analyzing an image of the customer to determine customer sentiment), determining a customer satisfaction score for the employee in response to aggregate customer satisfaction indicators for the employee, and using the customer satisfaction score to perform at least one action (e.g., automatically performing the action). Determining the customer satisfaction score may include determining whether a different employee also interacted with the customer. The action performed may be selected from the group consisting of recommend training for the employee, determine a rank for the employee, adjust a schedule of the employee, and adjust compensation of the employee.

In another aspect, a system for monitoring employee performance may include a database of instances of live employee-customer interactions, where for each record corresponding to a live employee-customer interaction in the database, the database includes a customer satisfaction indicator (e.g., generated by analyzing an image of the customer to determine customer sentiment), means for determining a customer satisfaction score for the employee in response to aggregate customer satisfaction indicators for the employee, and means for using the customer satisfaction score to perform at least one action (e.g., an automatic action). Determining the customer satisfaction score may include determining whether a different employee also interacted with the customer. The action performed may be selected from the group consisting of recommend training for the employee, determine a rank for the employee, adjust a schedule of the employee, and adjust compensation of the employee.

In another aspect, a method of testing a marketing campaign (e.g., a product change, a pricing scheme change, or an advertising change) may include determining a baseline feature of customer behavior (e.g., making a purchase), deploying a marketing campaign, measuring the feature of customer behavior during the marketing campaign, and comparing the behavior of customers before the marketing campaign to their behavior during or after the marketing campaign. Measuring the feature of customer behavior may include using a database of customers and an automatic customer-recognition system to recognize customers, and measuring the feature of behavior for the recognized customers. The method may include changing the marketing campaign midstream and measuring the effect of the change on customer behavior. The method may further include calculating an ROI for the campaign.

### BRIEF DESCRIPTION OF THE DRAWING

FIG. 1 is an overview of an implementation of the instant method.

FIG. 2 is a schematic drawing of an implementation of a profile capture device.

FIG. 3 depicts a record from a database of customer experience data.

FIG. 4 depicts processing steps for use with a profile capture device.

FIG. 5 shows a data window describing employee performance statistics.

FIG. 6 shows a data window describing site performance statistics.

FIG. 7 shows a flow chart for a method of monitoring employee or site performance.

FIG. 8 is a flow chart of a method of testing a marketing campaign.

FIG. 9 shows an analysis window for analyzing a marketing campaign.

### DETAILED DESCRIPTION

A more particular description of certain implementations of our Customer Experience Monitor may be had by reference to the implementations described below, and those shown in the drawings that form a part of this specification, in which like numerals represent like objects. It is understood that the description and drawings represent example implementations and are not to be understood as limiting. Drawings are not drawn to scale unless otherwise noted herein. The material included in U.S. Provisional App. No. 62/639,658, filed Mar. 7, 2018, is incorporated by reference herein to the extent not inconsistent herewith.

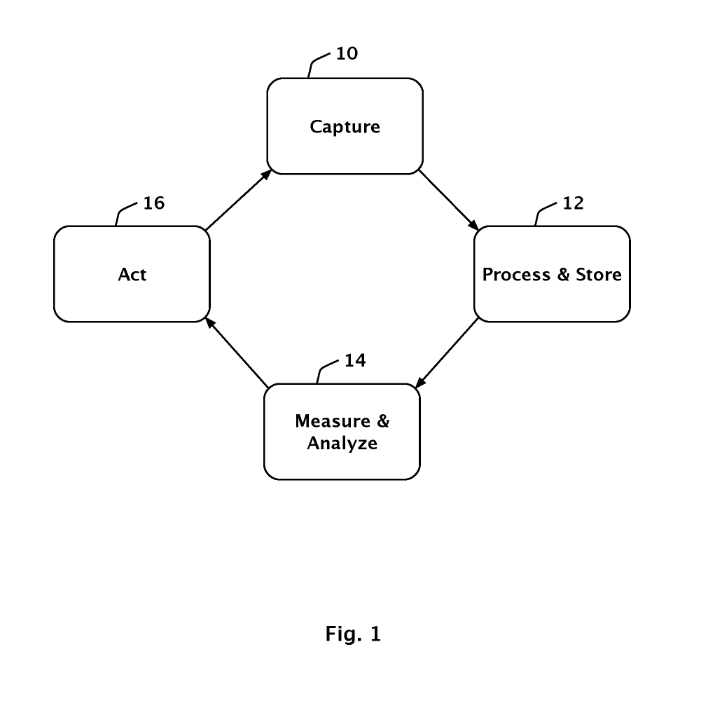

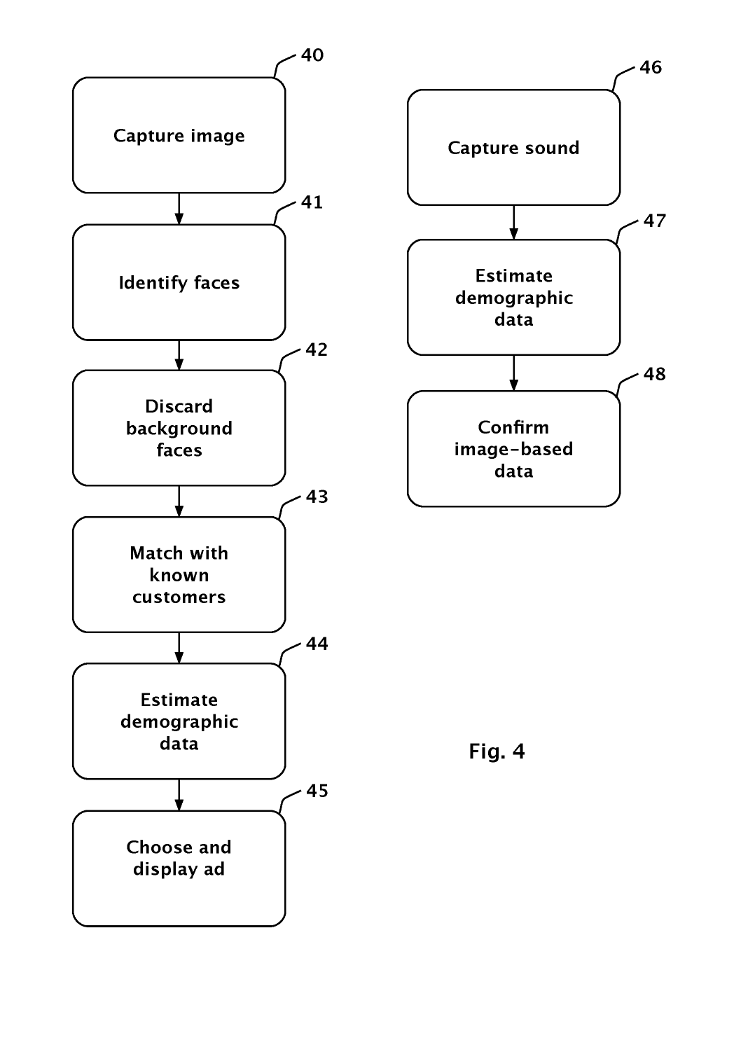

FIG. 1 is a flow diagram illustrating an implementation of a customer experience monitor. First, a profile capture system (e.g., an optical camera, an infrared camera, a microphone, a fingerprint scanner, a gait detector, a silhouette (profile) detector, a QR code reader, an RFID reader, a skeletal scan, a footprint scanner, or a brain scanner) captures 10 profile data such as still and/or video image(s) or a voiceprint of a customer. Profile data may include any information that tends to identify the customer as a specific person. In some implementations, it is contemplated that while the “customer” is still a person, the profile capture system is capturing the profile of an avatar of the person, such as a robotic shopper configured to shop for the customer. The profile capture system may be a fixed camera such as a security camera or microphone or a mobile device (such as a phone) conveniently placed to capture customer experiences, or it may be a mobile device, such as a device carried by an employee or affixed to a point-of-sale system or the like. The captured profiles are then processed and/or stored 12 by either a local or remote processor (as shown below in connection with FIG. 4). In some implementations (especially those in which images and/or sounds are captured by a cellular phone), it may be convenient to locally process captured profile data. For example, a face detection algorithm might be run locally and only the portions of the image that correspond to faces stored, in order to save memory. Alternatively, the system might send all captured profile data to a remote server for processing. In some implementations, the local system may dynamically shift the amount of local processing depending on the quality of its connection to a remote server, privacy preferences detected for a customer, or other appropriate parameters.

Once any local or remote preprocessing has been done in step 12, the profile data may be measured and analyzed 14. In some implementations, this processing may be local, while in others, it may be remote. The details of the measurement and analysis are described below in connection with FIG. 4, but in general, this step may provide employees and owners of the store with information about the identity, experience, and reactions of customers to experiences in the store. This information may then be used in the final act 16 step, in which actions may be taken in response to the data analysis. For example, an employee might be prompted to offer a particular “special,” or a manager might schedule an employee training. In some implementations, after the act 16 step, the profile capture system returns to capture step 10 and repeats the process, either continuing to record data pertaining to the same customer or moving on to the next one.

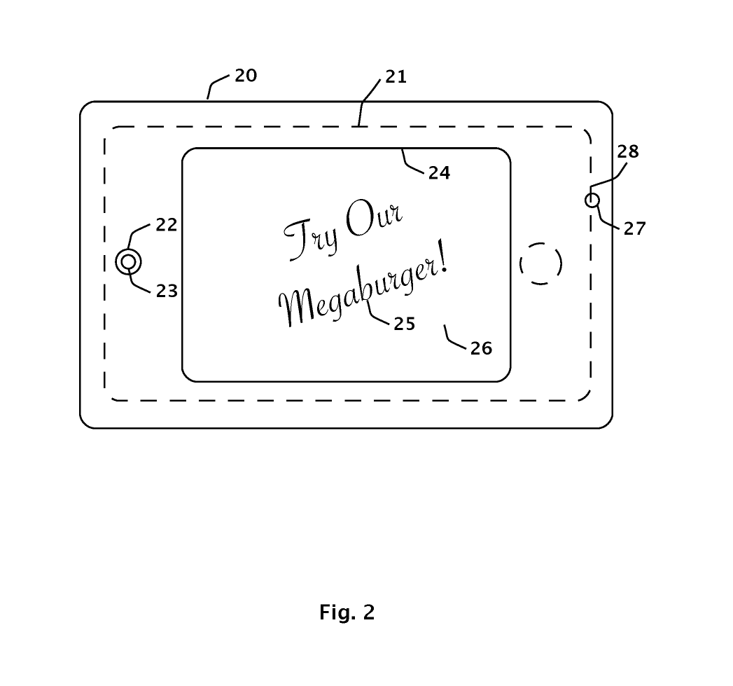

FIG. 2 is a schematic of a profile data capture device. The depicted device may include a frame 20 configured to hold a mobile phone 21. The frame may include an aperture 22 placed to allow a camera 23 in phone 21 to “see” a customer. The frame may further include a second aperture 24 that permits the customer to view an advertisement 25 displayed on phone screen 26, and/or a third aperture 27 that may permit a microphone 28 to allow the phone to collect sound data. In some implementations, the displayed advertisement 25 may automatically rotate to match the orientation of a viewer. In some implementations, frame 20 may include texture, printing, or other elements (not shown) that may tend to reduce the visibility of camera 23 and/or microphone 28 to the customer. In some jurisdictions, it may be required or advisable to notify the customer that he may be viewed by cameras or recorded by a microphone, or such viewing or recording may be prohibited. When operating in a jurisdiction in which certain types of recording are prohibited, the apertures 22, 27 may be absent, or may include covers (not shown). In some implementations, the system may itself determine what types of profile information may be collected, for example using a GPS system (or other location-determining methods such as local wi-fi networks or saved location data) to determine its legal jurisdiction (e.g., a one-party vs. a two-party sound recording state), and may adjust whether recordings are saved. Information about cameras and/or microphones may be displayed on screen 26, and/or it may be conveyed by other signage, voice recordings, or other means as permitted or advised by local statute. In some implementations, data based on sounds or images (such as matching faces or voices) may be saved without saving the underlying sounds or images, for example in order to comply with local privacy laws.

Frame 20 may be configured either for fixed deployment (for example, hung on a wall in a customer waiting area or on a point-of-sale terminal), or for mobile deployment (for example, on an employee lanyard or on a flying drone). Specific implementations include a mobile phone device with an optional display screen (fixed or mobile), wearable eyeglasses with a camera, contact lens with a camera, a mobile camera device attached to eyeglasses, a wearable body-camera device, a wearable watch device with a camera, or an electronic tablet device with camera and screen. Those of ordinary skill in the art will appreciate that there are many possible arrangements of single or multiple devices that may be deployed to gather customer experience data, depending on such factors as store size, store layout, typical employee-customer engagement patterns, and budget, and will understand how to select an appropriate configuration for a particular location.

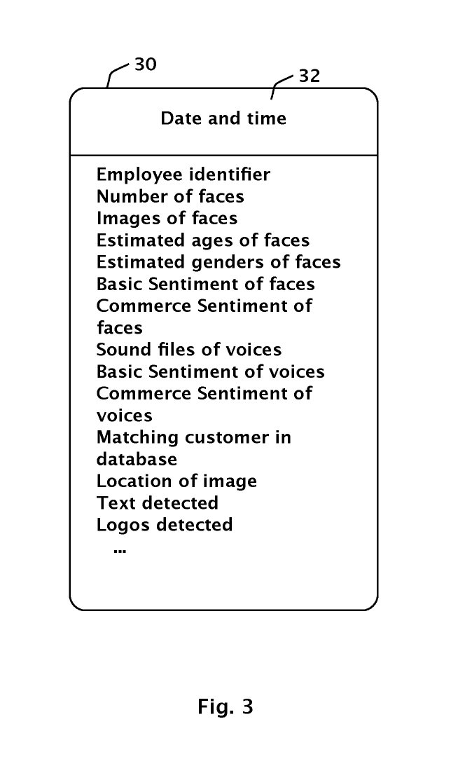

FIG. 3 depicts a record 30 for entry in a database of customer experience data. The record depicted may be created in the process and store 12 step of the method depicted in FIG. 1, by processing data collected by the device depicted in FIG. 2. As depicted, the record is indexed by a timestamp 32, but other methods of distinguishing between records produced by single or multiple devices are also contemplated. The timestamp shown may correspond to a single image captured by camera 23. Local processing (for example by phone 21) may extract face(s) from the image and save small images of each face for later matching to a database of customer and/or employee faces. In order to minimize memory and battery usage, in some implementations, only a small image of the face is saved, but the level of detail that is stored will depend on details of the available space and power. In some implementations, the full face may be saved, while in others, it may be downsampled, for example, to conserve memory. In some implementations, once a match for the face has been found, the face image itself may not be saved, while in other implementations, all faces may be saved for future comparisons. Similar considerations may govern the level of detail saved for other portions of the image, such as logos or text, which need not have the same thresholds or sizes saved. In some implementations, only faces within a certain range of sizes are saved, and the system does not attempt to identify faces that are small enough that they are “in the distance” with respect to the device. In some implementations, detected faces are compared with a database of employee faces, so that employees are not identified as customers to add to the database. If faces of employees are known to the system, they may also be used to monitor locations of employees to infer levels of customer engagement.

Those of ordinary skill in the art will understand that not all of the fields depicted as being part of record 30 need be captured in any given implementation of the system, and further that in some implementations, other fields may be captured. The depicted record 30 includes a timestamp, a number of faces detected, optionally downsampled images of faces detected, employee identifiers for faces matched to employees, an employee identifier associated with the device that captured the data (for example, the employee wearing the device as discussed above), record identifiers for faces matched to previous customers, estimated age and/or gender for imaged faces, estimated basic sentiment and commerce sentiment for imaged faces, optionally downsampled sound files of voices captured, estimated basic sentiment and commerce sentiment for voice data, location that data was captured, text detected, and logos detected. Other profile data that might appear in other implementations include estimated ethnicity, gaze parameters (e.g., yaw of eyes, record of whether customer actually looked at a display, or time spent looking at a display), size of a customer's group, distinguishing features of customer, accessories of customer (e.g., glasses, earrings, or other jewelry), action of customer. In some implementations, profile data may be combined with data that might be captured by other channels, such as ads viewed, purchases made, step of purchasing process, GPS location, sublocation, customer repeat data (e.g., number of visit, times and dates of previous visits). Any of the above features may also have a separate confidence level recorded as part of the database record.

FIG. 4 depicts local or remote processing steps that may be performed in the creation of record 30 depicted in FIG. 3. In some implementations, no local processing is performed (for example because the profile capture device(s) do not have appropriate processing power), while in other implementations, processing is done partially or entirely locally. In general, any of the steps may be selected to be performed locally or remotely, and this choice may be made dynamically, for example in response to considerations such as quality of remote connection, local and/or remote memory, local and/or remote speed, local and/or remote power availability, and/or location of customer history data. In one step, an image may be captured 40 and held in local memory or transmitted to a remote server (for example, to a local area network, to an internet-based server, or to a cloud-based server). Standard face-detection algorithms may be used to identify 41 faces shown in the image, for example commercially available face recognition systems such as Amazon REKOGNITION™ or Microsoft COMPUTER VISION API. In some implementations, identified faces below a selected size may be discarded 42, for example, because they may be too difficult to identify, because they may be far enough away that they may not be considered to be relevant to the customer experience, or simply to filter noise from the signal. In some implementations, identified faces above a certain size may be discarded, for example, because the intent is to capture impressions instead of interactions. The system may match 43 faces of known customers and estimate 44 demographic data such as age and gender of the customer. An advertisement 25 may be displayed 45 as described in connection with FIG. 2, and this advertisement may in some implementations be chosen in response to demographic data or to other customer features such as known prior purchases. Sounds may also be recorded 46 and used to estimate 47 demographic data or to confirm 48 image profile data. Faces may further be examined to determine an estimated sentiment (e.g., happy, angry, confused, etc.). Face sentiment may be an automatic function that may be provided by some face recognition systems.

In addition to face sentiment, the system may separately determine commerce-sentiment (e.g., interested, wanting to purchase, etc.). Commerce-sentiment may be determined, for example, by looking at a series of face images. Although the confidence level for basic emotions attached to a single image of a customer may not be high, it may be possible to obtain a more nuanced estimation of customer mood and of commerce-sentiment by examining a series of customer images. The frequency of capture of such images may vary depending on factors such as a location of a profile data capture system (e.g., a camera viewing a door with customers striding into a restaurant may require more frequent pictures than a camera viewing a line of waiting customers). In some implementations, the database may be updated with details of the “journey” of a customer through the store (e.g., as viewed by a camera at the entrance of a fast-food restaurant, by a camera watching a line of customers waiting to order, by a camera watching customers waiting to pick up after ordering, and by a camera watching a dining room that notices whether customers eat on the premises and how long they stay). Customer expressions may also be context-dependent. For example, expressions of customers in a drive-through line may be less animated than expressions of customers who are in the midst of interacting in person with a cashier.

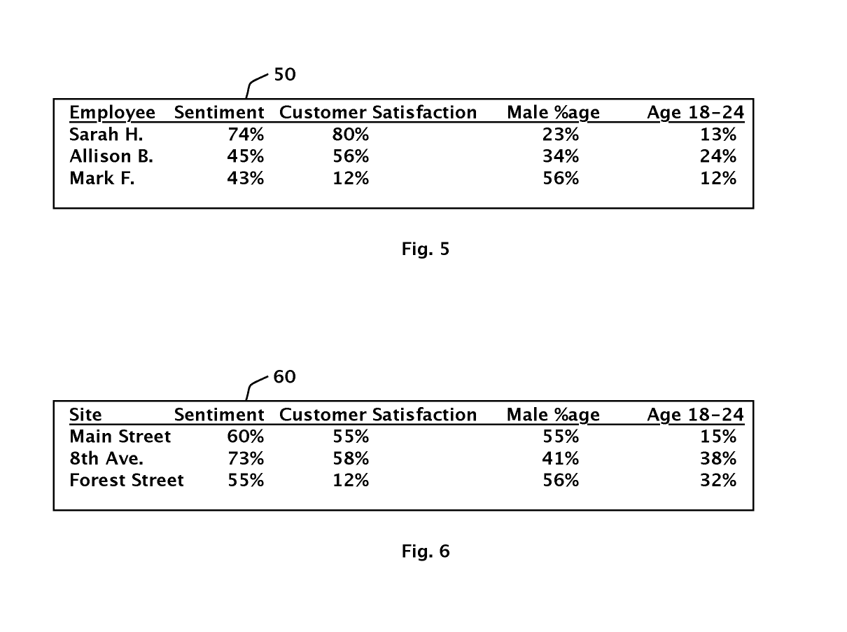

FIG. 5 shows an employee “dashboard” window 50 describing example statistics for a set of employees or contractors at a particular site. For each employee, the dashboard lists an average sentiment value, a customer satisfaction value, and an indication of a gender and age breakdown of customers served. It will be understood that the exact fields shown in FIG. 5 are merely an example, and that the dashboard configuration will vary for different users. The average sentiment value represents a measure of the overall “happiness” of customers as they enter the store, while the customer satisfaction value represents a measure of the overall sentiment of customers after interacting with the employee (either on an absolute scale or as a change from their initial sentiment value). In some implementations, the dashboard might also include such metrics as the average spending of customers served by the employee or whether the employee suggested additional purchases (“upsold”) to the customer during the transaction. Review of the dashboard values shows that Sarah H. is producing happier customers, while Mark F. may require customer service training. However, it is also possible that Mark F.'s relatively poor customer service values have more to do with his encountering a much more male clientele than Sarah H, rather than deficiencies in the service he provides. The merchant can use this data to investigate the customer service experiences provided by each employee to target appropriate training, schedule adjustment, and/or compensation for each.

In some implementations, the more detailed data may be available by clicking on the summary data shown in FIG. 5. In some implementations, a user may draw comparisons across the data filters, such as a comparison across employees during a specific time period, an aggregate comparison across all employees, comparison across employees in different locations, comparison across employees by industry, store, location, peer or management benchmarks, comparison across employees by age, comparison across employees by genders, comparison across employees by demographics, comparison across employees by interactions, comparison across employees across interaction duration, comparison across employees by sales numbers.

FIG. 6 shows a dashboard window 60 similar to the employee dashboard of FIG. 5, but showing site-specific data. The merchant can examine the data provided for each location to determine whether customer experiences can be improved at the Forest Street location, which appears to be underperforming relative to the other two locations. This difference might relate to the employees, or to the physical aspects of the store, or to the mix of customers encountered. If the merchant assigns the same employees to different locations on different days, he might look at their performance in different locations to isolate the possible cause of the relatively poor customer satisfaction in the Forest Street store in order to provide an improved experience there. As discussed in connection with FIG. 5, different implementations may allow the user to draw comparisons across a wide variety of data filters, such as a comparison across locations, comparison across industries, comparison across competitors, comparison across regions, comparison across time periods, comparison across weather, or comparison across products. Using the above measurements and data, a user can measure marketing data and performance for individual locations or across multiple locations, measuring sentiment, demographics, interactions, average duration of interactions, number of customers, new vs. returning customers, logos detected, clothing recognition, and impact on sales. This data can be used to understand the state of locations, understand how the data changes across locations/time periods, understand how this data changes per product offering and/or understand how customer appearance impacts interactions and sales.

The data shown in FIG. 5 and FIG. 6 may further be combined, filtered, and compared with external data which may include point of sale system (e.g., average revenue per interaction, sales numbers, number of employee interactions needed to make sale, number of unique employee interactions needed to make sale, average number of customer-employee interactions per visit), weather data, event data, location data, cellular data, wireless data, traffic data, marketing data and all other third party data sources. In some implementations, the results of the analytics described above can be imported, exported or enhanced with other employee/HR systems, scheduling systems, customer experience systems, customer service systems, marketing systems, workflow automation systems, security systems, CRM systems, helpdesk systems, customer satisfaction systems, social media, marketing automation, SEO, marketing analytics engines and/or any other relevant third-party systems.

In some implementations, the data analysis and results described above may serve as the basis for manual and/or automated action such as computer algorithms and/or human interaction. Resulting actions may include, but are not limited to, corrective action, rewards, motivations, incentive, coaching, scheduling, punitive action, staffing, merchandising, marketing, training, suggestions, product placement and/or visualizations. For example, if the system determines that the customer is a repeat customer who often orders a (premium) milkshake instead of a (standard) soft drink, the cashier might be prompted in real time to ask if the customer would like to upgrade his drink, or the advertisement displayed to that customer while waiting in line might include a milkshake. In some implementations, the system may provide real-time or near real-time data, for example alerting a store owner that customer loyalty is falling, or that there is a summertime run on milkshakes that could be exploited.

In some implementations, computer algorithms may process the data measurements/results referenced above and deliver customized user feedback based on, but not limited to, customer satisfaction scores (including all metrics relating to gender, age, sentiment listed above), sales numbers, interaction numbers, interaction duration metrics, industry metrics, store metrics, employee/contractor metrics and/or location metrics. This user feedback may be delivered to managers, owners, administrators, and/or directly to employees.

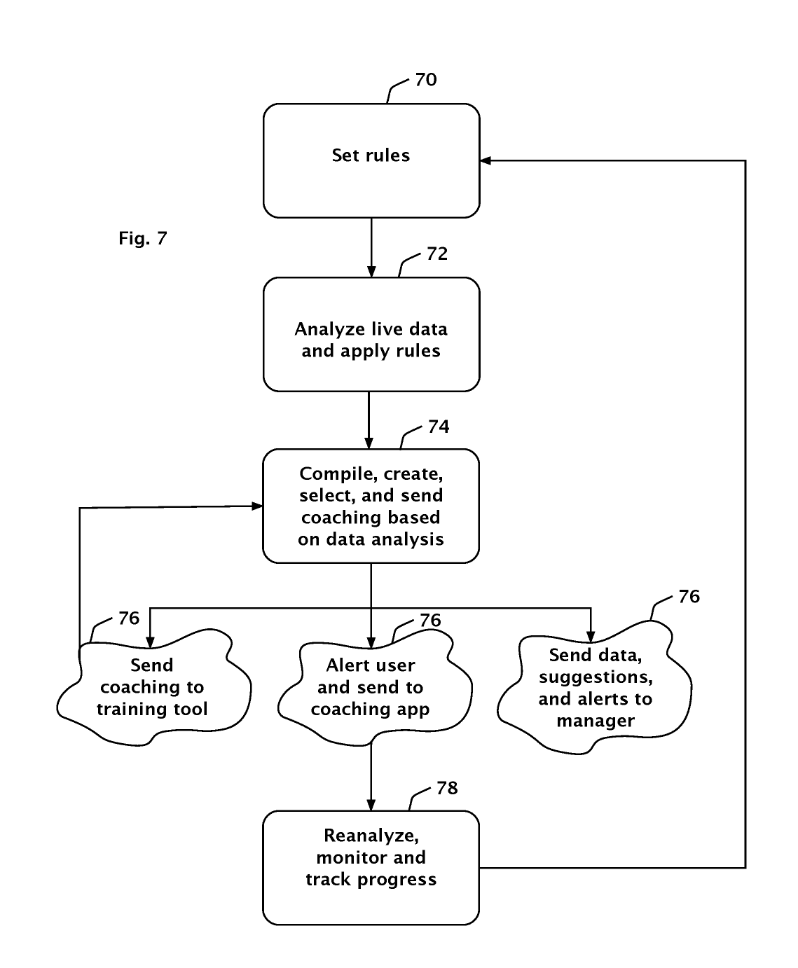

FIG. 7 shows one implementation of an algorithm to automatically suggest training or other responses to data such as that presented in FIG. 5 or FIG. 6. A user (such as a supervisor, manager, or administrator) may set 70 priorities for the system to analyze 72 where a user is weak in certain data metrics and automatically deliver 74 corresponding training content that references the area of weakness. The algorithm may also take other training-related actions 76, such as alerting a manager/admin via an app or other communication channel with a customized suggestion for content to be delivered manually. The computer algorithm may set rules based on suggested optimization/best practices or manual user input and apply defined rules to the live data set collected from the measurement device of a specific employee/user. The algorithm may be integrated with training, development and/or HR systems and automatically suggest and/or take action on training to optimize for metrics that include, but are not limited to, customer gender, customer age, customer sentiment, location traffic, demographics/skills of other employees, historical data. Once the algorithm has taken corrective or suggestive action, communication channels may notify admins/managers and users may be served content, suggestions or alerts as it relates to performance optimization. After actions have been taken, the algorithm may return 78 to the rules 70 step to refine or modify rules as appropriate based on the responses to actions 76. While FIG. 7 may depict specifically training actions, those of ordinary skill in the art will understand that other actions such as changing scheduling, providing bonuses or other incentives, or marketing actions may also be taken as possible actions 76 to complete the illustrated cycle of improvement.

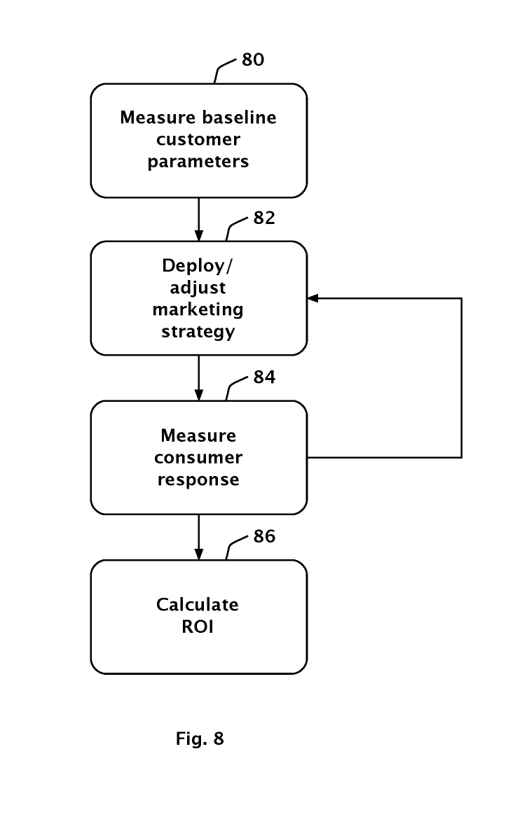

FIG. 8 shows a method of obtaining return-on-investment (ROI) data on a marketing campaign using the systems and methods described above. The depicted method may begin by determining 80 a baseline level of new customers and repeat customers. In other implementations, the baseline might be determining customer satisfaction and/or other customer behavior. A marketing strategy may then be applied 82 (e.g., offer a buy one/get one 50% off deal on burritos). Differences in customer behavior may be measured 84 and analyzed to establish how customers adjust (e.g., buying more burritos) and how the adjustments may affect overall profit and how many repeat visitors are brought in by the promotion. If appropriate, the campaign can be adjusted (e.g., changing to a buy one/get one free deal), and the effect of the adjustment can be further measured. After one or more iterations, any increased profit attributable to the marketing campaign can be compared to the required investment, to determine 86 an ROI for the campaign. In some embodiments, rather than immediate profit, the marketing campaign may be evaluated in terms of improving other desirable features such as customer loyalty.

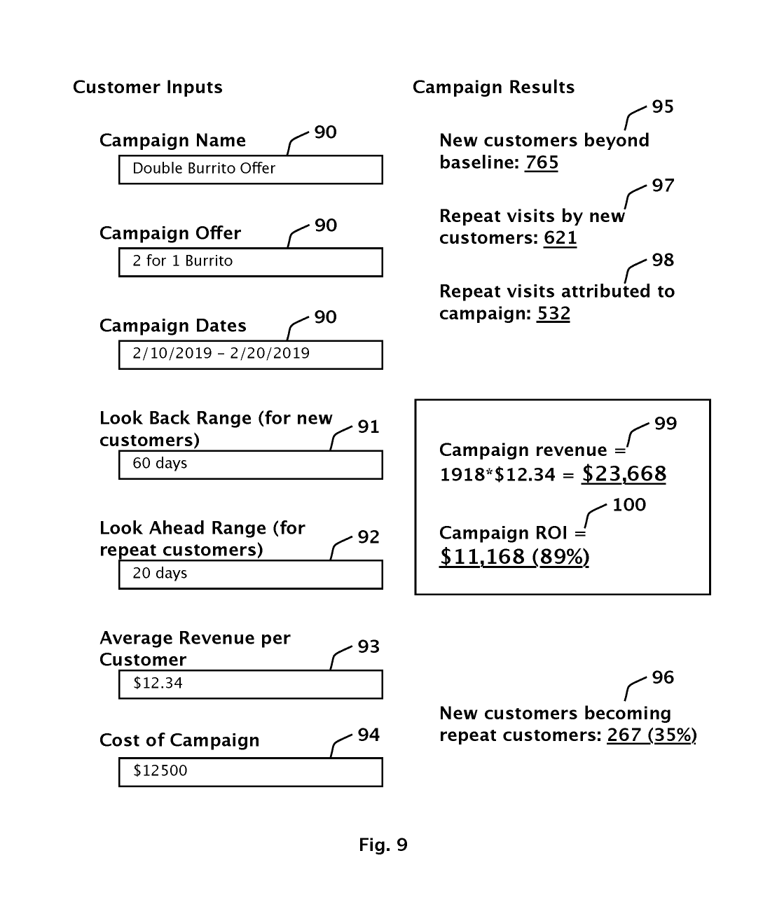

FIG. 9 shows a user interface for analyzing a marketing campaign as described in FIG. 8. The user inputs identifying campaign data 90 including the campaign name, description of the offer, and dates. The user further chooses a “look back” period 91, for how long the system will look back for a customer before classifying him as a “new” customer. (So, in the illustrated embodiment, a customer who has not visited the store in 90 days will be classified as “new” for purposes of analyzing the campaign.). The user also chooses a “look ahead” period 92, for looking to see if the campaign brings that customer back to the store. Finally, the user specifies an average revenue 93 for customers at the location, and a cost 94 of the marketing campaign. In some implementations, the system might use timestamps, point-of-sale data, or other specific marketing data to determine the average revenue of customers taking advantage of the office, rather than of all customers in the store. In some implementations, impressions of customers outside the store (e.g., customers walking by who look at advertising on the store window) might be used to determine which customers to use for calculating average revenue (e.g., so that a customer who looks at the 2-for-1 burrito advertisement, but after entering decides to order tacos instead, is still counted for purposes of determining the effectiveness of the advertisement).

With the above information, the software tool is able to use the specified dates and look back/look ahead periods to determine the number of new customers 95 that the campaign brought in (beyond the baseline number of new customers normally visiting the store), how many times those new customers visited again 97 after their first visit, and how many repeat customers 98 the campaign brought in. These data allow the program to calculate the campaign revenue 99 and the ROI 100 for the campaign. For other calculations of effectiveness, the screen also shows how many new customers became repeat customers 96.

While various aspects and embodiments have been disclosed herein, other aspects and embodiments will be apparent to those skilled in the art. The various aspects and embodiments disclosed herein are for purposes of illustration and are not intended to be limiting, with the true scope and spirit of the invention being indicated by the following claims.

1. A method for monitoring a customer experience, comprising:
collecting profile data for a customer;
comparing the profile data with a database of customers and using the comparison to determine that:
the customer matches a record in the database and is a repeat customer; or
the customer does not match any record in the database and is a new customer;
if the customer is determined to be a repeat customer, updating the database to add a current visit to the matched record;
if the customer is determined to be a new customer, adding a record of the customer to the database; and
recording at least one feature of the experience of the customer in the database and associating the recorded feature with the customer.

2. The method of claim 1, wherein the recorded feature is selected from the group consisting of products shown to the customer, products purchased by the customer, identity of employee serving customer, number of employees serving customer, duration of customer visit, time of customer visit, location of customer visit, method of payment used by the customer, customer sentiment, employee sentiment, logos viewed by customer, and scenes viewed by customer.

3. The method of claim 1, wherein collecting profile data for a customer includes determining demographic data for the customer.

4. The method of claim 3, wherein the demographic data includes at least one item selected from the group consisting of age, gender, family status, residence data, and job data.

5. The method of claim 1, wherein using the comparison includes determining a probability that the customer may match a record in the database and may be a repeat customer.

6. The method of claim 1, wherein collecting profile data for the customer includes collecting a still image of the customer.

7. The method of claim 1, wherein collecting profile data for the customer includes collecting a video image of the customer.

8. The method of claim 1, wherein collecting profile data for the customer includes collecting data from the customer selected from the group consisting of a sound, a gait characteristic, a silhouette, a QR code, an RFID code, a footprint scan, a fingerprint scan, a skeletal scan, and a brain scan.

9. The method of claim 1, wherein collecting profile data for the customer includes collecting the profile data with a mobile phone.

10. The method of claim 1, wherein collecting profile data for the customer includes collecting the profile data with a security camera.

11. The method of claim 1, wherein collecting profile data of the customer includes collecting the profile data with a point-of-sale device.

12. The method of claim 1, wherein collecting profile data for the customer includes determining a face size of the customer in a captured image and only storing the data if the determined face size falls within a selected range.

13. The method of claim 1, wherein collecting profile data for the customer includes determining an estimated age of the customer and only storing the data if the determined age falls within a selected range.

14. The method of claim 1, wherein collecting profile data for the customer includes collecting profile data using two or more profile capture devices.

15. The method of claim 1, further comprising displaying an advertisement to the customer during profile data collection.

16. The method of claim 1, wherein collecting profile data for the customer includes determining a location of the customer and determining whether to store collected profile data in response to the determined location.

17. The method of claim 16, wherein determining a location of the customer includes using a GPS device to determine the location.

18. The method of claim 1, wherein collecting profile data for the customer includes checking employee data to confirm that the collected profile data does not belong to an employee.

19. A system for monitoring a customer experience, comprising:
means for collecting profile data for a customer;
means for comparing the profile data with a database of customers and using the comparison to determine that:
the customer matches a record in the database and is a repeat customer; or
the customer does not match any record in the database and is a new customer;
means for updating the database to add a current visit to the matched record if the customer is determined to be a repeat customer;
means for adding a record of the customer to the database if the customer is determined to be a new customer; and
means for recording at least one feature of the experience of the customer in the database and associating the recorded feature with the customer.

20. The system of claim 19, wherein the recorded feature is selected from the group consisting of products shown to the customer, products purchased by the customer, identity of employee serving customer, number of employees serving customer, duration of customer visit, time of customer visit, location of customer visit, method of payment used by the customer, customer sentiment, employee sentiment, logos viewed by customer, and scenes viewed by customer.

21. The system of claim 19, wherein the means for collecting profile data for a customer includes means for determining demographic data for the customer.

22. The system of claim 21, wherein the demographic data includes at least one item selected from the group consisting of age, gender, family status, residence data, and job data.

23. The system of claim 19, wherein the means for using the comparison includes means for determining a probability that the customer may match a record in the database and may be a repeat customer.

24. The system of claim 19, wherein the means for collecting profile data for the customer includes means for collecting a still image of the customer.

25. The system of claim 19, wherein the means for collecting profile data for the customer includes means for collecting a video image of the customer.

26. The system of claim 19, wherein the means for collecting profile data for the customer includes means for collecting data from the customer selected from the group consisting of a sound, a gait characteristic, a silhouette, a QR code, an RFID code, a footprint scan, a fingerprint scan, a skeletal scan, and a brain scan.

27. The system of claim 19, wherein the means for collecting profile data for the customer includes means for collecting the profile data with a mobile phone.

28. The system of claim 19, wherein the means for collecting profile data for the customer includes means for collecting the profile data with a security camera.

29. The system of claim 19, wherein the means for collecting profile data of the customer includes means for collecting the profile data with a point-of-sale device.

30. The system of claim 19, wherein the means for collecting profile data for the customer includes means for determining a face size of the customer in a captured image and only storing the data if the determined face size falls within a selected range.

31. The system of claim 19, wherein the means for collecting profile data for the customer includes means for determining an estimated age of the customer and only storing the data if the determined age falls within a selected range.

32. The system of claim 19, wherein the means for collecting profile data for the customer includes means for collecting profile data using two or more profile capture devices.

33. The system of claim 19, further comprising means for displaying an advertisement to the customer during profile data collection.

34. The system of claim 19, wherein collecting profile data for the customer includes determining a location of the customer and determining whether to store collected profile data in response to the determined location.

35. The system of claim 34, wherein determining a location of the customer includes using a GPS device to determine the location.

36. The system of claim 19, wherein collecting profile data for the customer includes checking employee data to confirm that the collected profile data does not belong to an employee.

37. A method of monitoring employee performance, comprising:
assembling a database of instances of live employee-customer interactions, where for each record corresponding to a live employee-customer interaction in the database, the database includes a customer satisfaction indicator;
determining a customer satisfaction score for the employee in response to aggregate customer satisfaction indicators for the employee;
using the customer satisfaction score to perform at least one action selected from the group consisting of:
recommend training for the employee;
determine a rank for the employee;
adjust a schedule of the employee; and
adjust compensation of the employee.

38. The method of claim 37, wherein the performed action is performed automatically.

39. The method of claim 37, wherein the customer satisfaction indicator is determined by analyzing an image of the customer to determine customer sentiment during the live employee-customer interaction.

40. The method of claim 37, wherein determining the customer satisfaction score for the employee includes determining whether a different employee also interacted with the customer.

41. A system for monitoring employee performance, comprising:
a database of instances of live employee-customer interactions, where for each record corresponding to a live employee-customer interaction in the database, the database includes a customer satisfaction indicator;
means for determining a customer satisfaction score for the employee in response to aggregate customer satisfaction indicators for the employee;
means for using the customer satisfaction score to perform at least one action selected from the group consisting of:
recommend training for the employee;
determine a rank for the employee;
adjust a schedule of the employee; and
adjust compensation of the employee.

42. The system of claim 41, wherein the performed action is performed automatically.

43. The system of claim 41, wherein the customer satisfaction indicator is determined by analyzing an image of the customer to determine customer sentiment during the live employee-customer interaction.

44. The system of claim 41, wherein the means for determining the customer satisfaction score for the employee includes means for determining whether a different employee also interacted with the customer.

45. A method of testing a marketing campaign, comprising:
determining a baseline feature of customer behavior;
deploying a marketing campaign;
measuring the feature of customer behavior during the marketing campaign, wherein measuring the feature includes:
using a database of customers and an automatic customer-recognition system to recognize customers; and
measuring the feature of customer behavior for the recognized customers; and
comparing behavior of customers before the marketing campaign to their behavior during or after the marketing campaign.

46. The method of claim 45, wherein the marketing campaign includes a strategy selected from the group consisting of a product change, a pricing scheme change, and an advertising change.

47. The method of claim 45, further comprising, after measuring the feature of customer behavior for the customers, changing a component of the marketing campaign.

48. The method of claim 47, further comprising, after changing a component of the marketing campaign, measuring the feature of customer behavior for the customers again.

49. The method of claim 45, further comprising calculating a return on investment for the marketing campaign.

50. The method of claim 45, wherein the feature of customer behavior is making a purchase.
